(19) United States
(12) Patent Application Publication
(10) Pub. No.: US 2015/0012427 A1
(43) Pub. Date: Jan. 8, 2015

(54) Systems and Methods Related to Registration for Services

(71) Applicant: MASTERCARD INTERNATIONAL INCORPORATED, Purchase, NY (US)

(72) Inventors: Simon Phillips, York (GB); Alan Johnson, Rayleigh (GB)

(21) Appl. No.: 14/325,845

(22) Filed: Jul. 8, 2014

(30) Foreign Application Priority Data
Jul. 8, 2013 (GB) 1312236.1

(51) Int. Cl. G06Q 20/10; G06Q 30/00

(52) U.S. Cl. CPC G06Q 20/105; G06Q 30/018
USPC 705/41

(57) ABSTRACT

A method of associating a transaction device with a user profile on an activation computing device, the method comprising: receiving, from an issuing entity, information associated with a user profile, the user profile having been created by an issuing entity; generating, at the activation computing device, an activation code; sending the activation code to a transaction device associated with the user; receiving, from the transaction device, verification data, the verification data being associated with the activation code and the information associated with the user profile; validating, at the activation computing device, by comparing the received verification data with the generated activation code and the information associated with the user profile received from the issuing entity; and associating the transaction device with the user profile if the verification data is valid.

### FIELD

The present disclosure relates to registration for services, more particularly but not exclusively to the distribution of activation codes for initial registration for services on computing devices.

### BACKGROUND

When a user registers for a secure service, the service provider verifies that a user is genuine and legitimately registering for the service. For example, when the user registers (or “digitizes”) a physical payment card (such as contact or contactless integrated circuit chip card) with a digital wallet to create a digital card (i.e. a provision in the digital wallet that may be used in substantially the same way as the physical payment card), the digitization service provider confirms that the actual user of the physical payment card is the person requesting the digitization service.

Aspects of the digital card stored in the digital wallet may be different to the equivalent aspects of the physical card, for example, the digital card may have a new card number and/or account number. The digital card is typically located on a payment device, such as a mobile phone with near field communication (NFC). The digital card enables the user to carry out payment transactions with Points of Interaction (POIs), for example, point of sale terminals with NFC.

The physical payment card is sent to the user by an issuer, typically a financial institution that the user has an account with. The user may use the card to make payment transactions at POIs located at merchants. The POI reads the data held on the physical card, either on the magnetic stripe or, if the card is of the ‘chip and pin’ type, a chip integrated within the card (either by direct connection or by contactless connection), and generates a financial transaction.

The financial transaction may be a payment transaction seeking authorization for the amount of the transaction, or it may be a refund transaction, for example. The payment transaction is communicated by the merchant to a merchant acquirer which then routes the payment transaction to the issuer via the transaction processing entity for authorization. The issuer then carries out a series of checks to determine whether the user's credit is sufficient and to identify possible fraudulent transactions. If the checks are positive, the issuer then sends an appropriate authorization back to the acquirer to complete the authorization stage of the payment transaction.

Typically, an issuer has a suitable infrastructure to handle payment transactions relating to the physical cards that it has issued to its users. With the emergence of digital wallets, representations of the physical cards can be used to carry out financial transactions. Accordingly, it is desirable to securely and easily create digital cards that can be used in financial transactions and this may involve registering the physical card into the digital wallet.

It is an object of the present disclosure to provide a secure and simple method for registering for services.

### SUMMARY

According an aspect of the present disclosure there is provided a method of associating a transaction device with a user profile on an activation computing device, the method comprising: receiving, from an issuing entity, information associated with a user profile, the user profile having been created by an issuing entity; generating, at the activation computing device, an activation code; sending the activation code to a transaction device associated with the user; receiving, from the transaction device, verification data, the verification data being associated with the activation code and the information associated with the user profile; validating, at the activation computing device, by comparing the received verification data with the generated activation code and the information associated with the user profile received from the issuing entity; and associating the transaction device with the user profile if the verification data is valid.

The digitization of physical payment cards into non-physical digital cards requires the assurance that the actual cardholder is the person requesting the digitization process. The embodiments of the present disclosure described below address these issues so that digitization may be completed immediately in a simple manner, easily understood by all cardholders regardless of card issuer with an appropriate level of cardholder assurance.

The issuing entity (referred to below as the “issuer”) may, for example, be an entity that maintains user accounts and issues payment cards. The information associated with a user profile may comprise a user account number, payment card details (such as a payment card number, an expiry date for a payment card, a card security code etc.).

The transaction device associated with the user may comprise a mobile device, such as a mobile communications device, a computing device or a processing module within such a mobile device or computing device.

The activation computing device, referred to below as a digitization service provider, is arranged to receive the information associated with a user profile from the issuing entity and to generate an activation code for use in the digitization process. The activation code is sent to the transaction device.

When a user wishes to associate their transaction device with the user profile on the activation computing device, they may enter the activation code and information associated with their user profile into the transaction device. A verification data is then received at the activation computing device which proceeds to compare the received verification data with the activation code and information associated with the user profile that it holds. In the event that the verification data is valid the transaction device is associated with the user profile.

The verification data is associated with the activation code and the information associated with the user profile. For example, the verification data may comprise the activation code and the information associated with the user profile. Alternatively the verification data may comprise a verification code that is generated from the activation code and the information associated with the user profile.

The method may further comprise sending a communication to the transaction device that indicates that the verification data is valid.

In the event that the verification data comprises the activation code and the information associated with the user profile, then the process of validating may comprise comparing the received activation code with the generated activation code, and the information associated with the user profile received from the transaction device with the information associated with the user profile received from the issuing entity, and the process of associating the transaction device with the user profile may comprise associating the transaction device with the user profile if the activation code and information associated with the user profile are valid. In this arrangement, the method may further comprise sending a communication to the transaction device that indicates that the activation code and the information associated with the user profile are valid.

In the event that the verification data comprises a verification code derived by combining the activation code with the information associated with the user profile using a predetermined algorithm then the process of validating may comprise generating, at the activation computing device, a further verification code from the generated activation code and the information associated with the user profile received from the issuing entity using the predetermined algorithm and then comparing the received verification code with the further verification code, and the process of associating the transaction device with the user profile may comprise associating the transaction device with the user profile if the verification code and the further verification code match.

The information associated with the user profile may comprise a card security code, such as a CVC2 code.

The transaction device may be arranged to enable a user to make transactions using the user profile and conveniently sending the activation code may comprise sending the activation code to the user as part of a token transaction with the user profile. For example, a low value transaction may be made. The token transaction comprising the activation code may appear on a statement of transactions associated with the user profile. The activation code may be sent as part of a descriptor field in the token transaction with the user profile. The descriptor field may be a name of a merchant.

The activation code may be generated reactively following a request from a user such that the activation code is generated in response to a request from the user for an activation code.

The activation code may be generated proactively such that the activation code is generated in response to receiving the information associated with the user profile. In other words the activation code may be generated as a user account is created.

According to a second aspect of the present disclosure there is provided a method of activating a transaction device on a user computing device, the method comprising: receiving, at the user computing device, information associated with a user profile, the user profile having been created by an issuing entity; receiving, at the user computing device, an activation code, the activation code having been generated by an activation computing device; sending verification data, the verification data being associated with the information associated with the user profile and the activation code, to the activation computing device for validation; receiving a communication from the activation computing device; and activating the transaction device on the user computing device in the event the communication from the activation computing device indicates that the verification data is valid.

The information associated with a user profile may comprise one or more from a group comprising: a name of the user, an account number, a sort code, a payment card number, an address associated with a payment card, a payment card security code, an account balance, a credit amount and a debit amount.

The user computing device may comprise one from a group comprising: a phone, a watch, a personal computer and a tablet computer. The user computer device may comprise near field communication.

According to a third aspect of the present disclosure there is provided an activation computing device arranged to: receive, from an issuing entity, information associated with a user profile, the user profile having been created by an issuing entity; generate, at the activation computing device, an activation code; send the activation code to a transaction device associated with a user; receive, from the transaction device, verification data, the verification data being associated with the activation code and the information associated with the user profile; validate, at the activation computing device, by comparing the received verification data with the generated activation code and the information associated with the user profile received from the issuing entity; and associate the transaction device with the user profile if the verification data is valid.

The activation computing device may comprise an input and output to receive and send the above data and information to/from the user computing device. A processor within the activation computing device may be arranged to generate the activation code, validate the received information and associate the transaction device with the user profile.

According to a fourth aspect of the present disclosure there is provided a user computing device arranged to: receive, at the user computing device, information associated with a user profile, the user profile having been created by an issuing entity; receive, at the user computing device, an activation code, the activation code having been generated by an activation computing device; send verification data, the verification data being associated with the information associated with the user profile and the activation code, to the activation computing device for validation; receive a communication from the activation computing device; and activate the transaction device on the user computing device in the event the communication from the activation entity indicates that the verification data is valid.

The second, third and fourth aspects of the present disclosure may comprise features of the first aspect of the present disclosure.

The disclosure extends to a carrier medium for carrying a computer readable code for controlling an activation computing device to carry out the method of the first aspect of the disclosure and to a carrier medium for carrying a computer readable code for controlling a user computing device to carry out the method of the second aspect of the present disclosure.

The disclosure extends to a non-transitory computer-readable storage medium storing executable computer program instructions for implementing on an activation computing device the method of the first aspect of the disclosure. The disclosure extends to a non-transitory computer-readable storage medium storing executable computer program instructions for implementing on a user computing device the method of the second aspect of the disclosure.

### DRAWINGS

In order that the disclosure may be more readily understood, reference will now be made, by way of example, to the accompanying drawings in which:

FIG. 1 shows an example environment in which the present disclosure operates;

FIG. 2 shows a schematic block diagram of a mobile device of FIG. 1;

FIG. 3 shows a process flowchart according to the present disclosure;

FIG. 4 shows a schematic of a transaction statement comprising an activation code;

FIG. 5 shows a process flowchart of digitizing a card according to a first embodiment of the disclosure; and

FIG. 6 shows a process flowchart of digitizing a card according to a second embodiment of the disclosure.

### DETAILED DESCRIPTION

The digitization of physical payment cards into non-physical digital cards requires the assurance that the actual cardholder is the person requesting the digitization process. This process of determining that the requestor is the valid cardholder is typically initiated when the request for service is made, and may involve the distribution of passwords, codes or PINs to the genuine cardholder via trusted methods such as through the mail. An alternative is to use an existing issuer-supplied Identification and Verification method, such as those used by 3D secure-authenticated payments made at online merchants. However, many card issuers do not provide such services to authenticate cardholders and individual cardholders normally have to opt-in to such services therefore requiring access to such mechanisms which somewhat limits digitization. A digitization service provider may not have established, trusted methods of communication with a cardholder, as they are not their immediate customer and establishing new sufficiently trusted channels may delay the digitization process, which the cardholder may expect to be completed immediately.

In order to maximize the number of potential cards that may be digitized and to support all cards from all card issuers, regardless of what authentication methods individual issuers or cardholders support, a card digitization service needs to be able to authenticate every cardholder whose physical card has been made eligible for digitization by the card issuer using an alternative approach. The embodiments of the present disclosure described below address these issues so that digitization may be completed immediately in a simple manner, easily understood by all cardholders regardless of card issuer with an appropriate level of cardholder assurance.

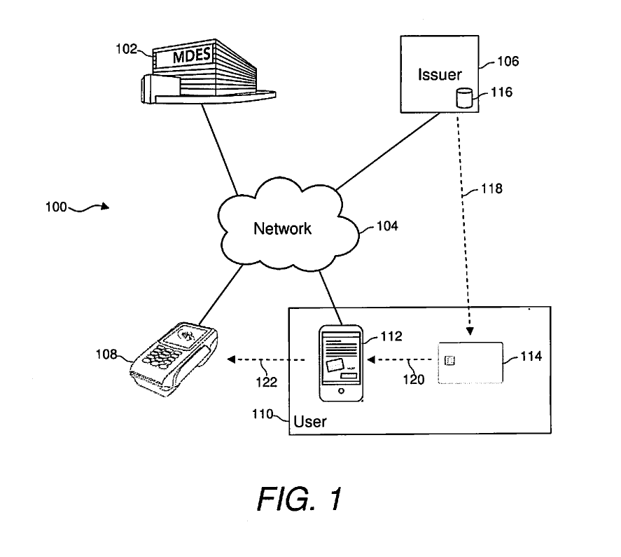

FIG. 1 shows an environment 100 in which embodiments of the present disclosure may operate. A digitization service provider 102 (illustrated as the MasterCard® Digital Enablement Service, MDES) is connected using a two-way data connection to a network 104, for example the Internet, a wide area network or a local area network. The digitization service provider 102 comprises an activation computing device. The environment 100 further comprises an issuer 106 and a POI 108 which comprise respective two-way data connections to the network 104. In this embodiment, the POI 108 is a point of sale terminal comprising an NFC communications module and located at a merchant. In other embodiments, the POI may be an online shopping checkout or an automated teller machine.

The environment 100 further comprises a user 110. The user 110 comprises a user computing device (i.e. mobile device 112, illustrated as a smartphone) and a payment card 114. Whilst the mobile device 112 is shown to be a smartphone in FIG. 1, it is to be understood that the mobile device in other embodiments may be a smartwatch or a tablet computer or any other suitable computing device.

The issuer 106 comprises a financial account 116 associated with the user 110. The payment card 114 is issued by the issuer 106 to the user 110 (illustrated by dashed arrow 118). The payment card 114 can be used by the user 110 to carry out financial transactions to and from their financial account 116 by ephemerally connecting the payment card 114 with the POI 108. The payment card 114 comprises a card number embossed onto the front of the payment card 114 and a card security code printed on the back of the card. For example, the card security code could be a card validation code (CVC), a card verification value (CVV) or a card identification number (CID). In other embodiments the card security code is printed on the front of the card. In some embodiments, the payment card 114 comprises an integrated circuit chip that can be used to carry out payment transactions directly with the POI 108.

The digitization service provider 102 is configured to digitize the physical payment card 114 into a non-physical digital card (illustrated by dashed arrow 120) stored in a digital wallet on the mobile device 112, as will be described below in more detail. This allows the mobile device 112 to be used to carry out financial transactions by ephemerally connecting with the POI 108 (illustrated by dashed arrow 122).

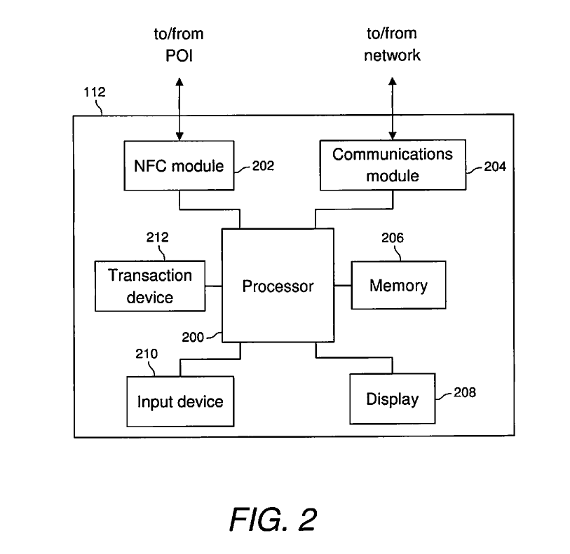

FIG. 2 shows the mobile device 112 in greater detail. The mobile device comprises a processor 200. The mobile device 112 further comprises an NFC module 202, a communications module 204, a memory 206, a display 208, an input device 210 and a transaction device 212. The NFC module 202, the communications module 204, the memory 206, the display 208, the input device 210 and the transaction device 212 are each connected to the processor 200.

The NFC module 202 is configured to connect to the POI 108 through a contactless data connection. The communications module 204 is configured to connect to the network 104. The memory 206 stores data associated with the digital wallet that manages the transaction device 212. The display 208 (i.e. a screen) is arranged to provide visual feedback to the user 110 and the input device 210 is configured to allow the user 110 to interact with the mobile device 112. For example the input device may be a microphone, a keyboard, a mouse, a touchpad, a directional pad etc. In other embodiments, the display 208 and the input device 210 may be combined, for example as a touchscreen.

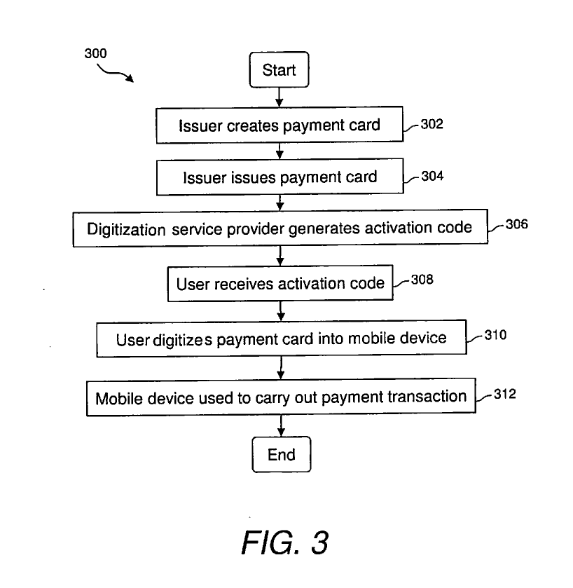

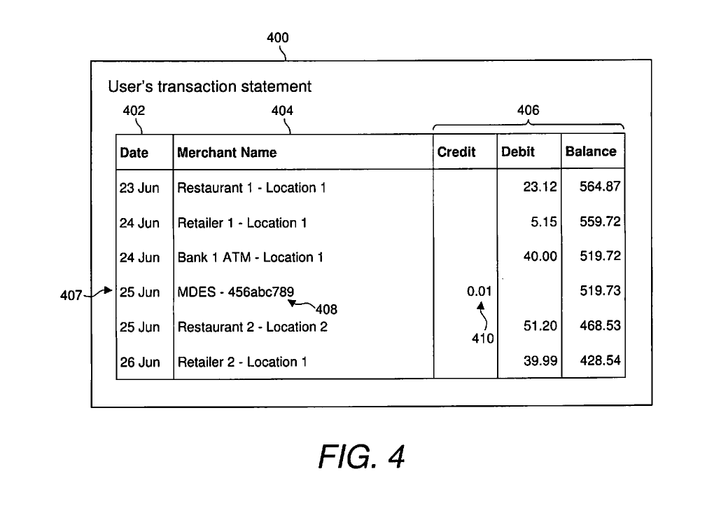

FIG. 3 shows a process 300 carried out by the entities of the environment 100. The process 300 starts with the issuer 106 creating at step 302 the payment card 114. The payment card 114 is then issued (i.e. sent) at step 304 to the user 110. The digitization service provider 102 generates at step 306 an activation code that is associated with the payment card 114. The user 110 receives at step 308 the activation code, described below in more detail with reference to FIG. 4. The user 110 then digitizes at step 310 the payment card 114 into the digital wallet of the mobile device 112 using the activation code received at step 308. The user 110 can then use at step 312 the mobile device 112 to carry out one or more payment transactions.

In other embodiments, the user 110 may request the digitization service provider 102 to generate at step 306 the activation code.

FIG. 4 shows a transaction statement 400 corresponding to a time period of activity related to the user's financial account 116. The transaction statement 400 is made available to the user 110 to allow the user to verify that authorised transactions have occurred on their financial account 116. The transaction statement 400 may be supplied to the user 110 through pre-existing issuer-defined cardholder identification and verification methods. For example, through post (i.e. a paper bank statement), online via a web browser or mobile application (i.e. online banking) or over a telephone call (i.e. telephone banking). Accordingly, the transaction statement 400 is sent to the user 110 through secure methods with the intention that the transaction statement 400 is only made available to the intended recipient.

The issuer 106 may add additional marketing materials explaining the digitization service with the transaction statement 400 to encourage the use of the digitization service.

The transaction statement 400 comprises a date 402, a merchant name 404 and the transaction amount 406 for each transaction within the time period of activity.

A token transaction 407 in the transaction statement 400 comprises an activation code 408, illustrated as “456abc789” in this example. The activation code 408 comprises alphanumeric characters and has been inserted into the transaction statement 400 by the digitization service provider 102. In other embodiments the activation code 408 may comprise symbols as well as alphanumeric characters. The activation code 408 can be used by the user 110 to digitize the payment card 114 into the mobile device 112.

In this embodiment, the activation code 408 is accompanied with a credit 410 into the user's financial account in the token transaction 407. In other embodiments, the activation code 408 may be a credit or debit of any or no value in the token transaction 407. Where the card issuer 106 has opted-in to offering the digitization service, the card issuer 106 may fund the payment. Alternatively, where the card issuer 106 has not opted in to offering the digitization service, the digitization service or another third party may fund the payment.

The activation code 408 may be randomly selected by the digitization service provider 102. In other embodiments, the activation code 408 may be derived algorithmically from the card number embossed onto the front of the payment card 114 and the card security code, thus allowing for the digitization of the card to be linked to possession of the payment card 114. In further embodiments an “initial PIN” may be algorithmically derived from the activation code 408 and the card security code as described below and this initial PIN used in the digitization process.

The card issuer 106 may determine whether each activation code 408 may be used only once or multiple times (for example, to digitize the payment card 114 into multiple mobile devices) and may limit the period of validity of each activation code 408.

The activation code 408 required to activate a digital card associated with a payment card 114 will appear on the cardholder's statement after the transaction has been cleared through the payment network. Typically this is within 2 days.

The activation code 408 may be distributed to the user 110 in either a proactive manner or a reactive manner. These two distribution methods are described in more detail below.

### Proactive Activation Code Distribution

In a first embodiment, the present disclosure may relate to a proactive code distribution process that identifies payment cards that are eligible for digitization and distributes activation codes 408 to users 110 in advance of their subsequent use during the activation of the digital card issued to mobile devices 112.

Where an issuer 106 does not opt-in to offer the digitization service to users which have financial accounts 116 with the issuer 106, eligible payment cards 114 may be identified by identifying qualifying card transaction activity within the payment transaction network. In an alternative arrangement, where issuers 106 opt-in to offer the digitization service to users which have financial accounts 116 with the issuer 106, eligible payment cards 114 may be identified by the issuer 106.

Where issuers 106 opt-in to offer the digitization service, the digitization service provider 102 may identify eligible payment cards 114 by creating card numbers within an opted-in card number range and verifying, using an Account Status Inquiry authorization message processed through the payment network to the issuer 106, that the card number is valid and that an account exists and is therefore eligible.

For every eligible payment card 114, regardless of the method used to determine eligibility, an associated activation code 408 is generated.

The issuer 106 may determine a date when the activation code 408 is generated and communicated to the user 110. The date may coincide with marketing campaigns or direct marketing of the digitization service.

By determining the activation code 408 for the payment card 114 in advance of the user's request to digitize their payment cards 114, the user can gain immediate access to the activation code 408, whenever it is needed, from their transaction statement 400.

To digitize the payment card 114 into the mobile device 112, it may be activated by entering the activation code 408 into the wallet application associated to create a digital representation of the payment card (i.e. digital card). The digital card cannot be used to carry out payment transactions until activated. The user 110 enters and confirms their own choice of personal identification number (PIN) that authorizes use of the digital card in contactless financial transactions. The NFC module 202 of the mobile device 112 can then be used to communicate with the POI 108 to carry out financial transactions. The digital card application validates that the activation code 408 entered by the user 110 matches the activation code provisioned by the digitization service. The user 110 sets the PIN for and activates the digital card.

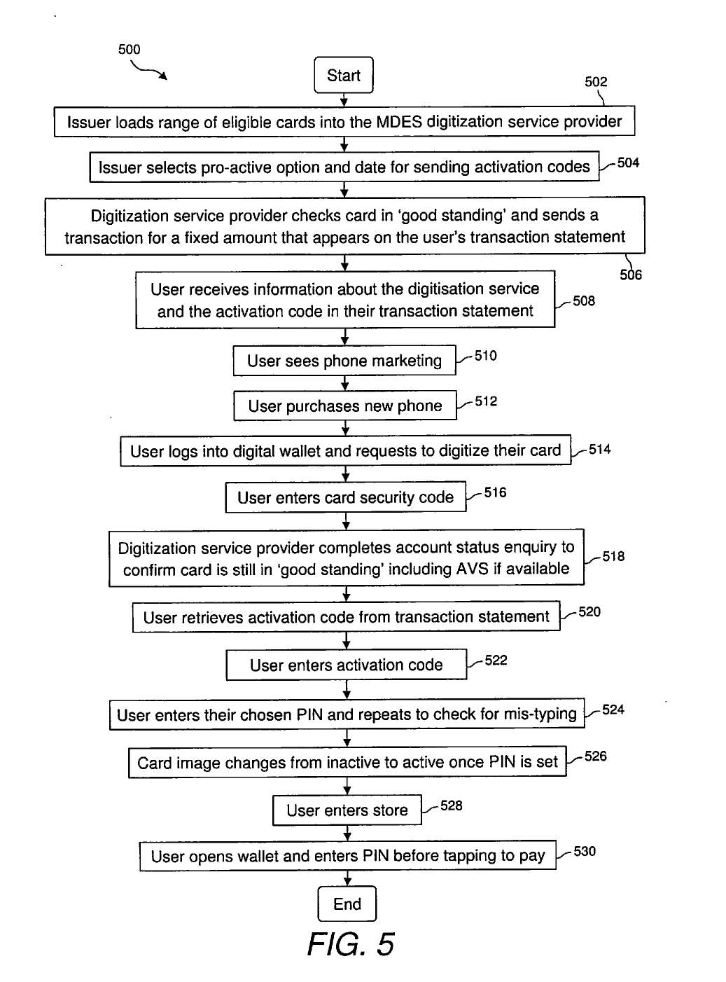

FIG. 5 shows a process 500 according to an embodiment of the disclosure wherein the activation code is sent to the user 110 proactively, i.e. before the user 110 decides that they wish to digitize their payment card.

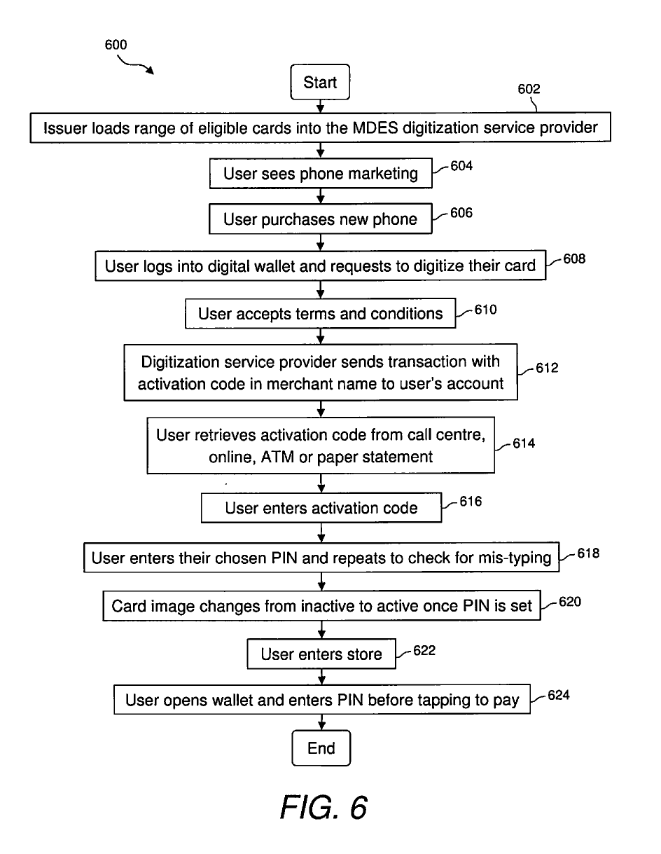

The process 500 begins with the issuer 106 creating a list of payment cards 114, that meet eligibility criteria for digitization and sending at step 502 the list to the digitization service provider 102. The issuer 106 elects at step 504 to proactively send activation codes 408 to each of the users 110 associated with eligible payment cards 114. The process wherein the issuer 106 decides not to proactively send activation codes 408 is discussed with reference to FIG. 6 below.

The following steps are then carried out for each of the eligible payment card but the discussion below refers to a single payment card 114 and associated user 110 for conciseness.

The digitization service provider 102 checks at step 506 that the payment card 114 is in good standing, for example, checking the credit rating of the user 110 or that historical credit card bills have been paid in a timely manner. Then the digitization service provider 102 sends, also at step 506, a payment transaction for a fixed amount to the user 110. According to the present disclosure, the digitization service provider 102 inserts an activation code 408 into the merchant name field 404 of the payment transaction. This causes the activation code 408 to appear on the user's transaction statement 400, for example, on a monthly paper statement, an electronic statement viewed online or at an automated teller machine. A payment transaction with a new activation code 408 may be sent to the user 110 once a month. Alternatively, the same activation code 408 is sent to the user 110 every month.

The user 110 receives at step 508 their transaction statement 400 along with marketing material about the digitization service. The marketing material raises awareness of the digitization service and may comprise, for example, promotional pamphlets/booklets sent directly to the user 110 or an advertising campaign online, on TV or on billboards. The marketing material emphasises a new payment device that is compatible with the digitization service, for example a mobile phone with NFC capabilities. The user 110 sees at step 510 the marketing material.

The user 110 purchases at step 512 a new mobile device 112 that is compatible with a digital wallet, either online or at a shop. Alternatively, the user 110 may already own a mobile device 112 that is compatible with the digitization service and would go straight from step 510 to step 514.

The user 110 then initiates the set-up process of digitizing their payment card 114 into the mobile device 112. This process only needs to be carried out once for each payment card 114 being digitized. The user 110 creates a digital wallet on the mobile device 112, or transfers an existing digital wallet to the mobile device 112. The user 110 logs into at step 514 their digital wallet on the mobile device 112 and requests, also at step 514, to digitize their payment card. Once the user 110 has agreed to the terms and conditions of the digitization service, the user 110 enters, at step 516, the card security code associated with the payment card 114.

The digitization service provider 102 confirms that the payment card 114 is still in good standing, including using an address verification system (AVS) to verify the address of the user 110 claiming to be in possession of the payment card 114, as it may have been several weeks or months since the initial check carried out in step 506. If the payment card 114 is still in good standing, the digitization process is allowed to continue.

The user 110 is then prompted to enter the activation code 408 by the digital wallet. The user 110 retrieves, at step 520, the activation code 408 from their transaction statement 400. The user 110 then enters, at step 522, the activation code 408 into the digital wallet.

The use of both steps 516 and 520 enhances the security of the process by requiring the user 110 to possess both the payment card 114 and have access to the transaction statement 400. The use of both steps 516 and 520 prevent fraudulent activation of the digitization service by a third party on their own mobile device. For example, if a fraudulent user was in possession of the user's payment card 114, the fraudulent user would not be able to digitize the payment card 114 without the transaction statement 400.

The user 110 creates at step 524 a secure personal identification number (PIN) and re-enters it to confirm that it was not entered incorrectly. The digital wallet indicates at step 526 to the user 110 that the payment card 114 has been successfully digitized.

The user 110 is then able to use the mobile device 112 to purchase goods and services. For example, the user 110 enters at step 528 a store such as a supermarket. At the supermarket checkout, the user chooses to pay with the mobile device. Therefore the user 110 opens at step 530 the digital wallet and enters the PIN on the mobile device 112. Then the user 110 initiates the payment transaction by bringing the mobile device 112 in sufficient proximity to the POI 108 for NFC to be functional. The POI 108 and the mobile device 112 communicate through the NFC connection and successfully complete the financial transaction.

In the description above relating to FIG. 5 it is noted that the user 110 sends the activation code 408 and the card security code (e.g. a CVC2 number) to the digitization service provider 102. The digitization service provider 102 is then able to check the validity of both the activation code 408 (against the code that was placed in the user's transaction statement 400) and the card security code (which may be supplied to the digitization service provider 102 from the issuer 106).

In an alternative embodiment however, the mobile device 112 may generate a verification code (an “initial personal identification number (initial PIN)”) from the entered card security code and the activation code 408 using a predetermined algorithm.

The mobile device 112 may then send the verification code to the digitization service provider 102 [in step 522 of FIG. 5]. The digitization service provider 102 may then compare the verification code from the mobile device 112 to a verification code that the activation service provider can generate using the same predetermined algorithm, the information associated with the user profile (i.e. the card security code) and the activation code. If the received verification code matches the generated verification code then the digitization process may continue.

In this alternative embodiment it is noted that user details may be entered during the process of logging into the digital wallet in step 514. This enables the digitization service provider 102 to locate the user's details and any payment cards that can be digitized.

In a still further embodiment, the mobile device 112 may generate the initial PIN as described above but additionally send further details relating to the payment card 114 (e.g. one or more of the card number, card security code, expiry date etc.).

### Reactive Activation Code Distribution

In another embodiment, the present disclosure is a process that distributes an activation code 408 to a user 110 for use in the activation of the digital card issued to a mobile device after a user initiates a request to digitize the payment card 114. In this embodiment, a user 110 requests the digitization of their payment card 114 by supplying the card number of their physical card, the card security code printed on the physical card and optionally their address to the digitization service. Alternatively, a third party service provider may pass the cardholder's stored “card on file” information instead, with the user providing only the card security code.

The digitization service provider 102 checks that the payment card 114 is eligible for digitization and verifies, using an Account Status Inquiry authorization message processed through the payment network to the issuer 106 that the card number is valid, a financial account 116 exists, the card security code is correct and, if supplied, that the address is correct, and is therefore eligible.

For every eligible payment card, an associated activation code 408 shall be generated and distributed to the user 110.

FIG. 6 shows a process 600 according to an embodiment of the disclosure wherein the activation code 408 is sent to the user 110 reactively, i.e. after the user 112 decides that they wish to digitize their payment card.

The issuer 106 creates a list of payment cards that meet eligibility criteria for digitization and sends, at step 602, the list to the digitization service provider 102. The issuer 106 has chosen to send activation codes to users after the users request to digitize their payment cards.

The following steps are then carried out for each of the eligible payment cards but the discussion below refers to a single payment card 114 and associated user 110 for conciseness.

The user 110 sees, at step 604, marketing material about the digitization service. The marketing material raises awareness of the digitization service and may comprise, for example, promotional pamphlets/booklets sent directly to the user or an advertising campaign online, on TV or on billboards. The marketing material emphasises a new payment device that is compatible with the digitization service, for example, a mobile phone with NFC capabilities.

The user 110 purchases, at step 606, a new mobile device 112 that is compatible with a digital wallet, either online or at a shop. Alternatively, the user 110 may already own a mobile device 112 that is compatible with the digitization service and would go straight from step 604 to step 608.

The user 110 then initiates the set-up process of digitizing their payment card 114 into the mobile device 112. This process only needs to be carried out once for each payment card 114 being digitized. The user 110 creates a digital wallet on the mobile device 112, or transfers an existing digital wallet to the mobile device 112. The user 110 logs into, at step 608, their digital wallet on the mobile device 112 and requests, also at step 608, to digitize their payment card. Once the user 110 has agreed, at step 610, to the terms and conditions of the digitization service, the user 110 enters the card security code associated with the payment card 114.

The digitization service provider 102 then confirms the good standing and verifies the address of the user 110. If the payment card 114 is in good standing and the address is verified, the digitization process is allowed to continue. The digitization service provider 102 sends, at step 612, a payment transaction for a fixed amount to the user 110. According to the present disclosure, the digitization service provider 102 inserts an activation code 408 into the merchant name field 404 of the payment transaction. This causes the activation code 408 to appear on the user's transaction statement 400.

The user 110 obtains, at step 614, the activation code 408. The payment transaction containing the activation code 408 may take up to two days to clear through the payment network and appear on the user's transaction statement 400. Alternatively, as the transaction comprising the activation code 408 appears to the issuer 106 almost immediately, the user 110 can telephone the issuer 106 to obtain the activation code 408.

The digital wallet application prompts the user 110 to enter the activation code 408 and the user 110 enters, at step 616, the activation code 408.

The user 110 creates, at step 618, a secure personal identification number (PIN) and re-enters it to confirm that it was not entered incorrectly. The digital wallet indicates, at step 620, to the user 110 that the payment card 114 has been successfully digitized.

The user 110 is then able to use the mobile device 112 to purchase goods and services. For example, the user 110 enters, at step 622, a store such as a supermarket. At the supermarket checkout, the user 110 chooses to pay with the mobile device 112. Therefore the user 110 opens, at step 624, the digital wallet and enters the PIN on the mobile device 112. Then the user 110 initiates the payment transaction by bringing the mobile device 112 in sufficient proximity to the POI 108 for NFC to be functional. The POI 108 and the mobile device 112 communicate through the NFC connection and successfully complete the financial transaction.

In the description above relating to FIG. 6 it is noted that the user 110 sends the activation code 408 and the card security code (e.g. a CVC2 number) to the digitization service provider 102. The digitization service provider 102 is then able to check the validity of both the activation code 408 (against the code that was placed in the user's transaction statement 400) and the card security code (which may be supplied to the digitization service provider 102 from the issuer 106).

In an alternative embodiment however, the mobile device 112 may generate a verification code (an “initial personal identification number (initial PIN)”) from the entered card security code and the activation code 408 using a predetermined algorithm.

The mobile device 112 may then send the verification code to the digitization service provider 102 [in step 616 of FIG. 6]. The activation service provider 102 may then compare the verification code from the mobile device 112 to a verification code that the digitization service provider 102 can generate using the same predetermined algorithm, the information associated with the user profile (i.e. the card security code) and the activation code 408. If the received verification code matches the generated verification code then the digitization process may continue.

In this alternative embodiment it is noted that user details may be entered during the process of logging into the digital wallet in step 608. This enables the digitization service provider 102 to locate the user's details and any payment cards that can be digitized.

In a still further embodiment, the mobile device 112 may generate the initial PIN as described above but additionally send further details relating to the payment card 114 (e.g. one or more of the card number, card security code, expiry date etc.).

Many modifications may be made to the above examples without departing from the scope of the present disclosure as defined in the accompanying claims.

For example, the digital wallet may be stored in the memory of a personal computer (i.e. a desktop computer or a laptop computer) which may connect to the POI via the network using the communication module.

Another example is where information associated with the account other than the card number and card security code may be provided as part of the digitization process.

A further example is where the issuer 106 and the digitization service provider 102 are part of the same entity.

It is noted that as an alternative to a PIN value that authorizes use of the digital card in contactless financial transactions, embodiments of the disclosure may use an alternative method of identifying a user, such as a biometric based system (e.g. facial recognition, signature recognition or fingerprint or finger vein scanning means).

In another embodiment, a non-transitory computer-readable storage medium storing executable computer program instructions is provided for implementing, on an activation computing device, the following operations (a) receiving, from an issuing entity, information associated with a user profile, the user profile having been created by an issuing entity; (b) generating, at the activation computing device, an activation code; (c) sending the activation code to a transaction device associated with the user; (d) receiving, from the transaction device, verification data, the verification data being associated with the activation code and the information associated with the user profile; (e) validating, at the activation computing device, by comparing the received verification data with the generated activation code and the information associated with the user profile received from the issuing entity; and (f) associating the transaction device with the user profile if the verification data is valid.

In still another embodiment, a non-transitory computer-readable storage medium storing executable computer program instructions is provided for implementing, on a user computing device, the following operations (a) receiving, at the user computing device, information associated with a user profile, the user profile having been created by an issuing entity; (b) receiving, at the user computing device, an activation code, the activation code having been generated by an activation computing device; (c) sending verification data, the verification data being associated with the information associated with the user profile and the activation code, to the activation computing device for validation; (d) receiving a communication from the activation computing device; and (e) activating the transaction device on the user computing device in the event the communication from the activation computing device indicates that the verification data is valid.

1. A method of associating a transaction device with a user profile on an activation computing device, the method comprising:
receiving, from an issuing entity, information associated with a user profile, the user profile having been created by an issuing entity;
generating, at the activation computing device, an activation code;
sending the activation code to a transaction device associated with the user;
receiving, from the transaction device, verification data, the verification data being associated with the activation code and the information associated with the user profile;
validating, at the activation computing device, by comparing the received verification data with the generated activation code and the information associated with the user profile received from the issuing entity; and
associating the transaction device with the user profile if the verification data is valid.

2. The method of claim 1, further comprising: sending a communication to the transaction device that indicates that the verification data is valid.

3. The method of claim 1, wherein:
(i) the verification data received from the transaction device comprises the activation code and the information associated with the user profile
(ii) validating comprises comparing the received activation code with the generated activation code, and the information associated with the user profile received from the transaction device with the information associated with the user profile received from the issuing entity, and
(iii) associating the transaction device with the user profile comprises associating the transaction device with the user profile if the activation code and information associated with the user profile are valid.

4. The method of claim 3, further comprising: sending a communication to the transaction device that indicates that the activation code and the information associated with the user profile are valid.

5. The method of claim 4, wherein:
(i) the verification data comprises a verification code derived by combining the activation code with the information associated with the user profile using a predetermined algorithm
(ii) validating comprises generating, at the activation computing device, a further verification code from the generated activation code and the information associated with the user profile received from the issuing entity using the predetermined algorithm and then comparing the received verification code with the further verification code, and
(iii) associating the transaction device with the user profile comprises associating the transaction device with the user profile if the verification code and the further verification code match.

6. The method of claim 1, wherein the information associated with the user profile comprises a card security code.

7. The method of claim 1, wherein, the transaction device is arranged to enable a user to make transactions using the user profile and wherein sending the activation code comprises sending the activation code to the user as part of a token transaction with the user profile.

8. The method of claim 7, wherein the token transaction comprising the activation code appears on a statement of transactions associated with the user profile.

9. The method of claim 7, wherein the activation code is sent as part of a descriptor field in the token transaction with the user profile.

10. The method of claim 9, wherein the descriptor field is a name of a merchant.

11. The method of claim 1, wherein the activation code is generated in response to a request from the user for an activation code.

12. The method of claim 1, wherein the activation code is generated in response to receiving the information associated with the user profile.

13. A method of activating a transaction device on a user computing device, the method comprising:
receiving, at the user computing device, information associated with a user profile, the user profile having been created by an issuing entity;
receiving, at the user computing device, an activation code, the activation code having been generated by an activation computing device;
sending verification data, the verification data being associated with the information associated with the user profile and the activation code, to the activation computing device for validation;
receiving a communication from the activation computing device; and
activating the transaction device on the user computing device in the event the communication from the activation computing device indicates that the verification data is valid.

14. The method of claim 13, wherein the information associated with a user profile is one or more from a group comprising: a name of the user, an account number, a sort code, a payment card number, an address associated with a payment card, a payment card security code, an account balance, a credit amount and a debit amount.

15. The method of claim 13, wherein the user computing device is one from a group comprising: a phone, a watch, a personal computer and a tablet computer.

16. The method of claim 13, wherein the user computer device comprises near field communication.

17. An activation computing device comprising a processor and a memory coupled to the processor, the memory including executable instructions that, when executed by the processor, cause the processor to:
receive, from an issuing entity, information associated with a user profile, the user profile having been created by an issuing entity;
generate, at the activation computing device, an activation code;
send the activation code to a transaction device associated with a user;
receive, from the transaction device, verification data, the verification data being associated with the activation code and the information associated with the user profile;
validate, at the activation computing device, by comparing the received verification data with the generated activation code and the information associated with the user profile received from the issuing entity; and
associate the transaction device with the user profile if the verification data is valid.

18. A user computing device comprising a processor and a memory coupled to the processor, the memory including executable instructions that, when executed by the processor, cause the processor to:
receive, at the user computing device, information associated with a user profile, the user profile having been created by an issuing entity;
receive, at the user computing device, an activation code, the activation code having been generated by an activation computing device;
send verification data, the verification data being associated with the information associated with the user profile and the activation code, to the activation computing device for validation;
receive a communication from the activation computing device; and
activate the transaction device on the user computing device in the event the communication from the activation entity indicates that the verification data is valid.

19. (canceled)

20. (canceled)
